(19) United States
(12) Patent Application Publication
(10) Pub. No.: US 2009/0034358 A1
(43) Pub. Date: Feb. 5, 2009

(54) Method and Apparatus for the Gassing and Degassing of Liquids, Particularly in Biotechnology, and Specifically of Cell Cultures

(75) Inventors: Helmut Brod, Köln (DE); Jorg Kauling, Koln (DE); Bjorn Frahm, Erkrath (DE); Reinhold Rose, Leverkusen (DE)

Correspondence Address: NORRIS, MCLAUGHLIN & MARCUS, PA, 875 THIRD AVENUE, 18TH FLOOR, NEW YORK, NY, 10022, US

(73) Assignee: Bayer Technology Services GMBH, Leverkusen (DE)

(21) Appl. No.: 12/280,565

(22) PCT Filed: Feb. 12, 2007
(86) PCT No.: PCT/EP2007/001162

§ 371 Date: Sep. 29, 2008

(30) Foreign Application Priority Data
Feb. 24, 2006 (DE) 10 2006 008 687.2

(51) Int. Cl. B01F 13/02

(52) U.S. Cl. 366/107

(57) ABSTRACT

A process and an apparatus for the bubble-free production of gas into liquids, in particular in biotechnology and especially of cell cultures, with gas exchange via one or more immersed membrane surfaces of any type (tubes, cylinders, etc.), with the membrane surfaces in rotary oscillating motion in the liquid.

The invention relates to a method and an apparatus for bubble-free gassing of liquids, particularly in biotechnology, and specifically of cell cultures.

The input and the desorption of gases is served by gassing liquids. The adequate supply of oxygen and carbon dioxide removal constitutes a problem particularly in the case of the supply and multiplication of cell cultures in culture media.

However, cell cultures occupy an evermore important position in the pharmaceutical industry, for example in the production of antibodies and proteins. Cell cultures are predestined particularly for the production of more complex substances, since they have an ability to produce highly glycosylated proteins with posttranslatory modifications.

Cell cultures place particular requirements on the reactors (and containers) in which they are cultivated. There is, for example, a need to avoid high shear forces, since these damage the cell membrane of the cells without cell walls. Shear forces are produced, for example, at agitators, or when gas bubbles burst at the liquid surface. Also to be avoided is the formation of foam, since cells tend to float with the foam. Inadequate cultivation conditions are present in the foam layer. The use of antifoaming means can also lead to cell damage or losses in yield during the workup, or to an increased outlay on workup.

Surface gassing is a type of cell culture gassing that takes account of some of the requirements outlined above. During surface gassing, the absorption and desorption of gases takes place over the surface of the liquid, that is to say the interface between reactor gas space and liquid. Since, depending on the surface-to-volume ratio, it is possible as a rule to use surface gassing to gas only a small liquid volume, submerged gassing is frequently employed. It is possible to distinguish between gassing with bubbles and bubble-free gassing. However, all types of gassing where bubbles occur have the disadvantages, set forth above, such as the formation of foam or bursting of the gas bubbles at the liquid surface. Furthermore, there is a need for the gas bubbles to be distributed and/or dispersed, for example by an agitator. However, this once again produces shear forces. It is true that the required gas transfer rates can be achieved, as a rule, with the aid of gassings that produce bubbles, but these lead at the same time to cell damage.

Bubble-free gassing solves the problem by virtue of the fact that the gas exchange takes place over a submerged membrane surface. Here, gassing is carried out with closed- or open-pore membranes. These are arranged, for example, in the liquid moved by an agitator. Silicone has proved itself as tube material by comparison with porous polymers. The reasons for this are the high gas permeability, the high thermal stability and the tube properties, which are distributed homogeneously over the length of the tube segments of up to 50 m, which are retained even after sterilization. The large tube lengths of the tube segments serve the purpose of shortening the time consuming production of the tube stators. The silicone tube is generally discarded after being used once.

A disadvantage of the previous instances of membrane gassing is the comparatively low mass transfer coefficient (H.-J. Henzler, J. Kauling: “Oxygenation of cell cultures” Bioprocess Engineering 9 (1993) pages 61-75) In order to achieve high mass transfer rates, it is necessary to install an appropriate number of membrane surfaces in the bioreactor. However, this is expensive as regards design and handling (mounting, sterilization, cleaning, production of regions with inadequate mixing, etc.). Furthermore, the power input can be increased. Since the mass transfer coefficient is a function of power input, this can result in raising the mass transfer rate. However, the potential is limited by the resulting shear load on the cells owing to the higher power input.

These boundary conditions result in the requirement that a corresponding membrane gassing deliver high mass transfer coefficients in conjunction with lower power input and/or low shear load at the same time. A secondary condition is that the mixing of the reactor space continues to be performed adequately. This must prevent the sedimentation of cells, on the one hand, while on the other hand enabling liquids to be mixed in sufficiently short mixing times.

In order to achieve this, a method and an apparatus have been described in EP 0172478 A1 for example, that have not so far been able to gain acceptance in practice. What is involved here is membrane tubes wound onto a basket, the basket executing an eccentric movement without natural rotation (!) in the interior of the bioreactor. However, this requires an eccentric apparatus. The mechanical apparatus of the eccentric must necessarily be provided in the reactor, that is to say inside a sterile region. On the one hand, this leads to problems in the sterilization of the eccentric apparatus, while on the other hand this is a constant source of risk for contamination of the sterile region. Furthermore, there is no sense in fitting in a sterile region an apparatus such as an eccentric apparatus that requires maintenance, which is mechanically complicated. It may be assumed that the need for the eccentric apparatus, and the problems associated therewith, have prevented the application of this patent. It was therefore the object of the present invention to provide a method and an apparatus for bubble-free gassing of cell cultures that is effective, performed in a fashion that is not damaging and is easy to clean.

It has surprisingly been found that the object set is achieved by means of a method for the gassing of liquids, particularly liquids used in biotechnology, and specifically of cell cultures, having a gas exchange over one or more submerged membrane surfaces of any desired type (tubes, cylinders, (*not yet published) etc.), the membrane surface executing an arbitrary, rotating and oscillating movement in the liquid.

An example of such an arrangement and movement is illustrated schematically in FIG. 1, the membrane surface being formed in this case by membrane tubes (1) that are arranged vertically on a rotor shaft (2) in a fashion transverse to the rotation direction (3).

During a rotating and oscillating movement, the membrane surface firstly moves in one rotation direction, it being possible for the movement to have any desired configuration. An example is the acceleration of the membrane surface with a specific angular acceleration up to a specific angular velocity, at which the membrane surface then moves for a specific time. Subsequently, the membrane surface is braked down to a standstill at a fixed deceleration. After a fixed standstill time, if appropriate, the movement in the other rotation direction follows. This movement can take place as a mirror image of that previously described or may be of some other configuration.

The rotating and oscillating movement offers the following advantages in this case:
It is easy to implement by controlling the drive motor appropriately.
From the design and mechanical aspect, there are no additional requirements, by contrast with more complex movements such as are disclosed in EP 0172478 A1, for example.
It is possible by targeted modification of the movement to optimize the latter such that the flow onto the membrane surface is optimum. Since the mass transfer coefficient is a function of the flow onto the membrane surface, a movement in the case of which the membrane surface in each case exhibits a speed relative to the liquid that is as high as possible is optimum. However, the liquid is also accelerated by the membrane surface. Were the membrane surface to rotate only in one direction, this would result after a certain time in a corotation of the liquid, and therefore in no/still only slight mass transfer. Baffles would be necessary in order to produce a relative speed between the membrane surface and liquid. By contrast, in the case of the rotating and oscillating movement a permanent corotation of the liquid is prevented by the periodic movement reversal of the membrane surface. A sensible movement looks as follows, for example: acceleration of the membrane surface in such a way that the speed relative to the liquid is as high as possible in conjunction with a low power input/low shear load. If a further acceleration of the membrane surface is not sensible, for example because this reaches excessively high speeds, or the liquid corotates to an undesired extent, the membrane surface is decelerated. Here, the movement is to be prescribed such that once again the speed relative to the liquid is as high as possible in conjunction with a low power input/low shear load. Except for a period as short as possible in which, upon deceleration, the membrane surface has the angular velocity of the liquid, there is otherwise always a high relative speed present. Upon the subsequent movement reversal and execution of the mirror image movement, the corresponding state of affairs arises once again. Here, a relative speed is still present at the movement reversal even when the membrane surface is at a standstill, since the liquid is decelerated more slowly than the membrane surface and is still “lagging”. Such a movement cycle is illustrated in FIG. 2 with reference to the position of membrane tubes that are fitted in star shape, to their angular velocity and to the torque for producing this movement sequence. The upper diagram in FIG. 2 shows by way of example the position of the rotor onto which the membrane tubes are wound. The marked period (approximately 8-12 seconds) corresponds to a rotating and oscillating movement sequence. Here, the rotor accomplishes a movement by 180° determined in one rotation direction, and back again. The associated angular velocity is illustrated in the lower diagram of FIG. 2. Furthermore, this shows the torque measured on the drive spindle, the idle torque having been subtracted. The denotation idle torque denotes that torque which is required to drive the rotor with the same movement sequence in the same container, but without liquid. The torque plotted thus corresponds to the torque which acts on the liquid. It can be correlated with the flow around the membrane surface. In this example, the profile of the torque is approximately box shaped. Thus, for a certain period the torque has approximately equal values until the sign then changes within a very short time. This illustrates that the flow around the membrane surface is of uniform configuration and good, except for the short period in which the sign of the torque changes.
A further advantage of the rotating and oscillating movement of the membrane surface is the fact that a separate agitator or mixer for producing a flow onto the membrane surface is eliminated. This unification of the provision of membrane surfaces and the production of flow onto the membrane surface avoids zones of locally high power input and locally high shear load. These are otherwise produced behind the outer ends of the agitator blades, for example. Furthermore, in other systems the flow onto the membrane surface takes place irregularly in time and space in that the agitator blades periodically pass by the membrane surfaces attached at one side. In the case of the invention described here, by contrast, the power input occurs in a spatially more uniform fashion and directly serves for the flow onto the membrane surface.
The inventive configuration of the method and of the apparatus results in a targeted liquid movement at all points of the membrane surface, and thus in a higher, defined mass transfer owing to the movement of the membrane surfaces relative to the liquid.
Thus, the inventive method and the inventive apparatus result overall in a better ratio of mass transfer and the mechanical power input required to produce the mass transfer than in the case of conventional methods and apparatuses.

A control of the oxygen supply as a function of requirement can be achieved by changing the rotating and oscillating movement. The variation in the movement effects a changed flow around the membrane surfaces, and this effects, in turn, a change in the mass transfer.

Controlling the oxygen supply as a function of requirement can be performed by controlling a change in the gas concentration and/or in the pressure of the gas or gas mixture or of a gas component flowing into the space inside the membrane surface. The possibility of control for the flow out of the space inside the membrane surface turns out to be similar.

When an appropriate pressure is applied to the membrane surface, the latter can also be used to produce microbubbles or gas bubbles in the liquid. This is advantageous in the case of robust cell lines that tolerate gassing with bubbles. The mass transfer coefficient can be raised thereby.

Non-porous silicone tubes of various diameters and wall thicknesses are, for example, suitable as membrane surfaces. Said wall thicknesses preferably lie in a range of inside diameter ˜1 mm in the case of an outside diameter of ˜1.4 mm, to an inside diameter of ˜2 mm in the case of an outside diameter of ˜3 mm. The parameters of tube diameter and total tube length should be selected so as to ensure adequate mass transfer for the application.

The mass transfer is determined, inter alia, by the ratio of membrane surface to reactor liquid volume (volume-specific mass transfer surface). Common values here are from 25 m⁻¹ to 45 m⁻¹ for animal cell cultures. In the present invention, the volume-specific mass transfer surface reaches values of between 0.1 m⁻¹ and 150 m⁻¹, preferably 1 m⁻¹ to 100 m⁻¹, and with particular preference 5 m⁻¹ to 75 m⁻¹.

However, the mass transfer is further determined by the mass transfer coefficient from the gas phase in the tube to the liquid phase around the tube, and by the corresponding driving concentration gradient. The operating parameter of internal membrane pressure resulting therefrom arises from the desired mass flows through the membrane, and is bounded above by two limits. On the one hand, the material loadability of the silicone tube permits only a specific internal membrane pressure, while on the other hand bubbles are possibly already formed on the outer surface of the membrane to an undesired extent when pressure is low. The internal membrane pressure results from the appropriate setting of the following parameters: volume flow through the membrane, and pressure at the start of the membrane tube and pressure at the end of the membrane tube. The other operating parameter that results, that is to say gas concentration in the liquid phase, arises from the operating conditions and the cultivation conditions.

Setting the pH value via a buffer CO₂ equilibrium, as is customary in cell culture technology, can usually be achieved by admixing the requisite CO₂ quantity into the incoming gas.

The inventive method and the inventive apparatus are also advantageously suitable for bubble-free gassing of microcarrier cultures.

The inventive method and the inventive apparatus are also advantageously suitable for application of dialysis, for example for optimized processing control of fermentations. The metabolic products and/or byproducts produced during fermentations can be removed by dialysis. Some metabolic products and/or byproducts are partially undesired, since they have a toxic effect in specific concentration ranges, or have a disadvantageous effect on the fermentation in specific concentration ranges. This can be performed, for example, by inhibiting the growth or the product formation. Furthermore, metabolic products and/or byproducts must, if appropriate, be separated from the actual product in downstream processing, there being a resultant increase in effort and costs. The dialysis offers the possibility of removing metabolic products and/or byproducts from the cultivation space (R. Pörtner, H. Märkl: “Dialysis cultures” Applied Microbiology and Biotechnology 50 (1998) pages 403-414). Low molecular weight components such as, for example, metabolites can diffuse via the dialysis membrane, while the cells and the product are kept back in the cultivation space. Dialysate is located on the side of the dialysis membrane opposite the cultivation space. The low molecular weight components are removed via a (continuous) exchange of the dialysate. Furthermore, there is also the possibility of introducing components (for example substrate) in the dialysate at higher concentrations than in the cultivation space. It is thereby possible for components to be specifically replaced by being metered into the cultivation space. Dialysis membranes relating to applications of dialysis described above can, for example, be fitted on the rotor in the form of modules. This fitting can be performed, for example, instead of one or more membrane surfaces, or else in addition to them.

The inventive apparatus is characterized by the features set forth below:

The apparatus comprises a rotatably mounted rotor that can be moved in the interior of the container, for example a bioreactor. The rotor is configured in such a way that it can carry in the interior of the bioreactor membrane surfaces such as tubes, cylinders, modules etc. for example.

The rotatably mounted rotor can be set moving in a rotating and oscillating fashion from outside the bioreactor by a drive. The transmission of the requisite drive torque from the drive onto the rotor in the interior of the reactor can either be performed via a magnetic coupling, or the rotor shaft is guided via a rotating seal through the housing of the bioreactor and coupled directly to the drive. The use of a magnetic coupling is particularly advantageous from the point of view of sterility, because it separates sterile and non-sterile spaces from one another unambiguously and without a rotating seal.

As drive for producing a rotating and oscillating movement, the power being made available by the motor must suffice for using the rotor to carry out an oscillating movement with a prescribed movement cycle despite the movement of inertia of the rotor and the fluid. Both the moment of inertia of the rotor and the effect of the force of the fluid are thus decisive for the design of the drive. Given an adequate rotational speed of the motor, a gear offers the possibility of providing the requisite torque. By way of example, an eccentric drive comes into consideration as drive configuration. An eccentric drive, for example, comes into consideration as drive configuration. An eccentric drive converts the uniform rotation of a conventional drive motor into a rotating and oscillating movement on the output shaft. Also coming into consideration as drive configuration for the inventive apparatus are freely programmable positioning drives such as, for example, a stepping motor. The advantage of such freely programmable drive systems resides in the fact that the rotating and oscillating movement of the membranes can be adapted within wide ranges to the requirements of the process, whereas an eccentric drive has only limited possibilities of adjustment, as a rule.

Parameters of the drive such as rotational speed, torque and gear ratios can be freely selected for the respective application and depend on the scale. For applications in the field of biotechnology, the parameters are usually fashioned so as to produce a volume-specific power input of 0.01 W per m⁻³ up to 4000 W per m⁻³ liquid volume, preferably around 1000 W per m⁻³.

The volume-specific power input for cell cultures is usually 0.01 up to 100 W per m⁻³.

Furthermore, the parameters should be fashioned so as to produce for cell culture application maximum relative speeds between rotor and liquid of 1 m s⁻¹, better 0.15 m s⁻¹.

In order to absorb the stresses arising from the connection between gear and rotor, the gear is usually connected to the rotor via any desired torsion-proof coupling that absorbs a slight shaft offset or a slight misalignment of the shafts, for example a bellows coupling.

The design of the apparatus for fitting the membrane surface can advantageously easily be adapted to the particular conditions in cell cultures, for example cell agglomeration. This can be performed, for example, by means of the type and arrangement of the membrane surfaces.

The rotor has the number of rotor arms that is required for the application, this being, depending on application, 1 to 64, preferably 2 to 32, and with particular preference 4 to 16 rotor arms. The problem of selecting the number of rotor arms will be explained later in more detail. The rotor arms can be linear (for example FIGS. 1, 8, 9, 10) or branched, in this case preferably linear or Y-shaped (for example FIG. 11), and are preferably arranged in star-shaped fashion on a holder. Any further desired arrangements are conceivable in addition to the star-shaped arrangement. Advantages of star-shaped arrangements or branched star-shaped arrangements or bent star-shaped arrangements (for example FIG. 7) are a very uniform distribution of the membrane surface in the liquid volume, effective flow onto the membrane surface and good mixing. The rotor arms are mounted symmetrically or asymmetrically on the rotor shaft and arranged inside the reactor space. The membrane surface, preferably the membrane tubes, is fastened on each rotor arm at regular or irregular spacings, for example by being wound, being suspended, by means of snap locks, or of other methods known in the literature.

In a particular design of the apparatus, two winding arms form a rotor arm. The membrane surface, preferably the membrane tubes, is wound onto these winding arms horizontally or vertically (for example winding arms on 9, 10 in FIG. 12 for vertical winding) at regular (see FIG. 13) or irregular spacings (corresponding to FIG. 13, although not every depression of the rotor arms has been given a membrane tube).

If the rotor now rotates, the membrane tubes are moved by the fluid in the reactor, and are thereby flowed onto tangentially. With regard to the flow onto the membrane tubes, it is to be borne in mind that given the same angular velocity, the oncoming flow generally improves as a function of the position of the membrane tube with increasing radial distance from the rotor shaft. The reason for this is the likewise increasing circumferential speed. It is preferred to install as many membrane tubes as possible in a fashion as far as possible outside in conjunction with good oncoming flow. One possibility of meeting this demand consists in increasing the number of the rotor arms around the shaft. However, increasing the number of the arms has a negative effect both on the mixing and on the flow onto the membrane (creating fewer mixed compartments between the arms). In addition, the increasing number of the arms makes it difficult to handle the rotor when winding the tubes on and off and during installation and dismantling. Again, fastening the arms on the shaft becomes increasingly problematic with a larger number of arms, for reasons of space.

Supplying the rotating and oscillating membrane surface for the supply and removal of gas is preferably performed from the stationary surroundings, for example the reactor lid, with the aid of a rotary seal or of flexible tubes. Rotary seals are mostly not desired in cell culture technology, since they can cause difficulties with cleaning and sterilization. This is an advantage of the inventive apparatus by comparison with an apparatus in which the membrane surfaces are moved in a purely rotational fashion, that is to say without reversal of the movement direction. Without reversal of the movement direction, the tubes would become ever more strongly twisted and finally break off with increasing rotation. Because of the to and fro movement, there is no net torsion of the flexible tubes in the case of rotating and oscillating membrane surfaces. Of course, this presupposes that the to and fro movement is fashioned in such a way that the membrane surfaces are located at the starting point of the movement after the end of a period of the movement.

A further advantage of the apparatus with wound membrane tubes is that the tension σ of the membrane surface, for example the membrane tubes, can be varied (FIG. 3). The optimum tension is obtained with the aid of the parameters of pressure of the gas or gas mixture flowing into the space inside the membrane surface, pressure of the gas or gas mixture flowing out of the space inside the membrane surface, and geometry, flow resistance and deformation of the space inside the membrane surface (these being, for example, in the case of a membrane tube, inlet pressure, outlet pressure, inside diameter, number and geometry of the curvatures of the membrane tube, and the deformation of the curvatures) (H. N. Qi, C. T. Goudar, J. D. Michaels, H.-J. Henzler, G. N. Jovanovic, K. B. Konstantinov: “Experimental and Theoretical Analysis of Tubular Membrane Aeration for Mammalian Cell Bioreactors” Biotechnology Progress 19 (2003) pages 1183-1189). In the case of membrane tubes, the reduction in the tube tension leads to a magnified deflection of the tubes during the movement. A larger deflection of the tubes improves the flow around them, and thus the mass transfer coefficient. Depending on the type of application, the tension is to be selected such that the membrane tubes on the one hand are fastened with long term stability while, on the other hand, preferably being able to move in the flow and to be deflected by a few mm. With a conventional diaphragm gassing system comprising a stator that carries the membrane surfaces, and a rotor that ensures the movement of the liquid, this advantage cannot be realized, or can only just be realized, because when the tension of the membrane tubes is too low there is the risk of them coming into contact with the rotor and being destroyed. Such damage cannot occur with the inventive apparatus, because there is only a single moving part in the reactor which, at the same time, carries the membrane surface itself.

In the particular embodiment of the apparatus, the tube tension can vary owing to the vertical spacing between the apparatuses for holding the winding arms being enlarged (compare FIG. 12). A fine setting of the membrane tube tension is enabled, for example, via the rotation of the screws in the tensioning apparatus (8).

The reduction in tube tension results in the problem of fixing the membrane tubes on the winding arms. In the event of low tube tension, a large effect of power on the membrane tubes could cause the membrane tubes to slide down from the winding arms. In order to contrast this problem, the surface of the winding arms is provided with an external thread, for example. Alternatively, it is possible by way of example to provide outside on the winding arms webs that prevent the tubes slipping down the arms on the outside. It is to be ensured here that the wound-on membrane tubes are not damaged by any possible burrs on the thread. Furthermore, the external thread on the winding arms of the star holder offers the possibility of varying the tube winding. For example, when winding the tubes it would be possible to use only every second or third thread depression. It is thereby possible to set a defined spacing between the individual membrane tubes.

It was already evident in the abovementioned patent EP 0172478 A1 that mixing in the case of such a system is not without problems. With regard to mixing, the movement guidance in this invention is more favorable because of the oscillating rotor movement. One possibility of forcing the axial mixing is setting the angle of the membrane surface (FIG. 4).

The exchange of the liquid inside the reactor in a direction parallel to the rotation axis of the moving membranes is, in particular, improved thereby. For example, the incidence angle of the membrane tubes can be varied by means of any desired radial rotation of an apparatus (for example 9 or 10 from FIG. 12). As regards design, the apparatuses (9, 10) are preferably able to be rotated independently of one another and variably in relation to one another.

In a further configuration of the apparatus, straightening elements are mounted on the rotor shaft (compare (4) in FIGS. 5 and 6 as well as 12). These straightening elements are either constructed as winding arms, or comprise two rods. They are arranged inside the reactor space such that they support the tubes appropriately on one side, or sculpt them.

A further possibility of improving mixing is provided by the straightening elements by virtue of the fact that the deflection, caused by the flow resistance, of the membrane surface is limited in one rotation direction (for example by means of straightening elements (4) in FIG. 5). The deflection of the membrane surface in one rotation direction is thereby stronger than in the opposite direction, and this results in a weaker conveyance of the liquid in this direction. The unequal conveyance of the liquid in the two movement directions of the rotating and oscillating rotor leads to a net conveyance in one direction and thus to a better mixing of the liquid.

The straightening elements with the aid of which the deflection of the membrane surfaces is limited in one rotation direction can be distributed uniformly or non-uniformly over the length of the membrane tubes. These elements are arranged in the reactor such that the desired effect is attained (see the experimental setup illustrated in the section “Example”, and the measurement results presented). When, for example, these apparatuses are located only in the lower third of the reactor, the flow resistance at different levels differs. In the case of the oscillating rotary movement of the inventive apparatus, this results in an additional mixing of the liquid in the direction parallel to the rotation axis.

In addition to the possibility of supporting the membrane tubes against deflection on one side (compare also FIG. 5), there is a further possibility of promoting mixing, namely sculpting the membrane tubes (for example with a bulge on one side, compare also FIG. 6). The sculpting creates asymmetry of the flow patterns of the two movement directions. By way of example, in terms of design the support or sculpting is permitted by the use of the straightening elements (4) from FIG. 12. The straightening elements (4) with the aid of which the deflection of the membrane surfaces is delimited in one rotation direction, can be distributed uniformly or non-uniformly over the length of the membrane tubes. This apparatus is preferably fashioned such that the straightening elements can be mounted to be variable both in level and in alignment. For example, they can be placed and fixed wherever desired on the shaft by loosening or fastening two grub screws.

In a further refinement of the invention, the mass transfer and the mixing can additionally be increased by fitting stationary baffles in the interior of the reactor. These disturb the flow that forms owing to the rotating and oscillating movement of the membrane surfaces.

In a particular configuration of the apparatus, mixing is improved by virtue of the fact that the oscillating and rotating membrane apparatus possesses no rotational symmetry. Thus, for example, in the case of the star-shaped arrangement of rotor arms in FIG. 1 onto which the membrane surfaces are wound, it is possible to leave out one or more of the arms such that a gap results. Mixing of the liquid in the reactor is improved as a matter of course by this breaking of the rotational symmetry. A further advantage of this asymmetric arrangement is a possibility of accommodating sensors, dip tubes etc. in the resulting gap without thereby impeding the movement of the gassing apparatus. Of course, this holds only as long as the amplitude of the oscillation of the membrane is small enough for no contact to arise between the submerged apparatuses (sensors, dip tubes etc.) and the membrane.

In order to improve mixing further, in particular to ensure that particles (microcarriers, cells or cell agglomerates) are reliably suspended, in addition to the membrane surface the membrane surface of the oscillating and rotating apparatus can also be equipped with flow guidance elements and mixing elements such as, for example, agitator blades, paddles or others, particularly in the vicinity of the reactor base, in order to prevent the sedimentation of these particles (compare agitator (5) in FIG. 6).

A further possibility of improving mixing consists in designing the rotor arms in a bent fashion around the rotor shaft in one of the rotation directions (FIG. 7). This forces radial mixing during rotation in both rotation directions.

It is further possible to improve mixing by the rotor arms being fitted on an apparatus tangentially around the rotor shaft in one of the rotation directions (compare (6) in FIG. 8). Here, as well, radial mixing is forced during rotation in both rotation directions. Moreover, mixing in the region of the rotation axis is improved by virtue of the fact that a cylindrical region free of membrane surface is automatically produced here as a result of the tangential arrangement of the rotor arms.

Another possibility of improving mixing consists in fitting the rotor shaft eccentrically in the container (FIG. 9). The reasons are the flow asymmetry in combination with a region free from membrane surface.

Independently thereof, mixing can be improved by admittedly fitting the rotor shaft with the two rotation directions centrally in the container, but also by the rotor shaft having an eccentric (compare (7) in FIG. 10). The reasons for this are the flow asymmetry in combination with a variable region free from membrane surface that varies permanently during movement of the rotor.

Otherwise than in the case of conventional apparatuses for membrane gassing of liquids, with the inventive apparatus there is the possibility of distributing the membrane surface per volume as uniformly as possible in the reactor (FIG. 11). This results in a spatially homogeneous absorption and desorption of gas, something which is particularly desired in cell culture technology.

The aim is preferably for the design to enable a variable and simple assembly of the individual parts. Thus, it is preferably possible to remove the rotor arms individually. This yields the possibility of winding the membrane tubes onto the pairs of arms before mounting on the rotor. The pairs of arms can therefore also be dismounted from the rotor individually. Winding aids can be constructed in order to enable the separate winding of the membrane tubes onto the individual pairs of arms.

Dip tubes fitted in the reactor (for example for feeding medium or alkali/acid, or for harvesting or for taking samples) reduce the reactor volume that can be used by the rotor. This may be accompanied by, for example, a reduction in the membrane surface that can be accommodated in the reactor. One possibility of counteracting this is for dip tubes or else probes or other reactor internals to be integrated in the rotor. These parts are therefore also moved, but this is generally disadvantageous. On the contrary, it is possible thereby to have a better distribution of the substances fed, or a representative withdrawal of liquid, for example harvest, or a more representative measurement.

The weight of the rotor is preferably low such that the moment of inertia of the rotor remains as small as possible. The power of the drive that is to be provided can be reduced by a low moment of inertia. As a result, the inventive apparatus is preferably therefore fashioned to be as light as possible in conjunction with adequate stability.

The method and/or the apparatus for the bubble-free gassing of liquids, particularly in biotechnology, specifically of cell cultures, preferably takes place at the respectively optimum temperature. This is usually the optimum cultivation temperature in the case of microorganisms or cell cultures.

### FIGURES

FIG. 1 is a schematic of a rotating and oscillating movement for gassing and degassing liquids by means of a membrane surface in a container. Here, the membrane surface is formed by membrane tubes (1) wound onto a rotor. Said membrane surface rotates with the rotor shaft (2) in both rotation directions (3).

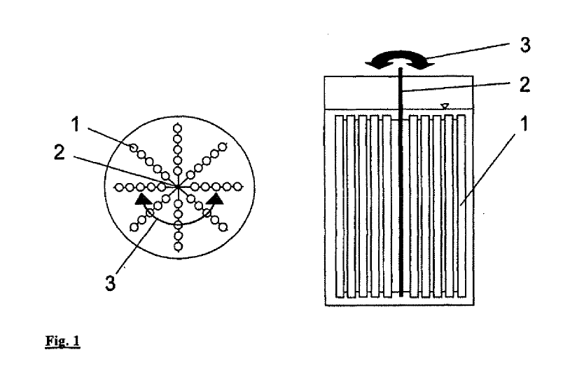

FIG. 2 shows the position, angular velocity and torque of a rotating and oscillating movement for gassing and degassing liquids by means of a membrane surface. Here the membrane surface is formed by membrane tubes wound onto a rotor.

FIG. 3 is a schematic of the apparatus, characterized by a possibility of varying the tension of the membrane surface σ, for example of the membrane tubes. Here the membrane surface is formed by membrane tubes wound onto a rotor.

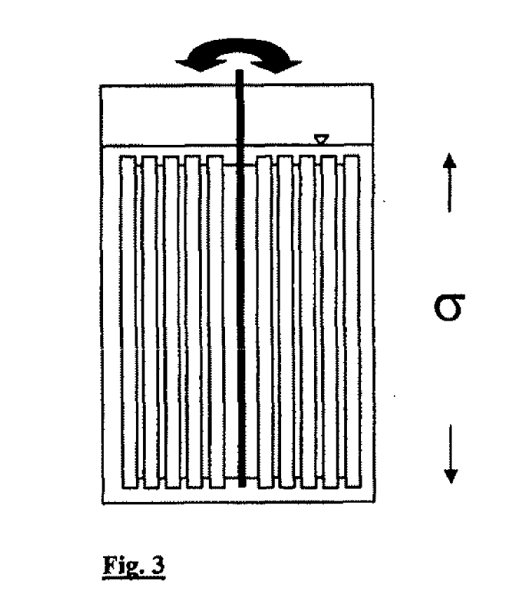

FIG. 4 is a schematic of the apparatus, characterized by a possibility of varying the incidence angle of the membrane surface. Here, the membrane surface is formed by membrane tubes (1) wound onto a rotor.

FIG. 5 is a schematic of the apparatus, characterized by a possibility limiting the deflection, caused by the flow resistance, of the membrane surface by means of straightening elements (4) in one rotation direction. Here, the membrane surface is formed by membrane tubes (1) wound onto a rotor.

FIG. 6 is a schematic of the apparatus, characterized by a possibility of shaping the membrane surface appropriately by means of straightening elements (4) for the purpose of better mixing, and/or also of fitting agitator blades/paddles (5) or other apparatuses for flow guidance and mixing. Here, the membrane surface is formed by membrane tubes (1) wound onto a rotor.

FIG. 7 is a schematic of the apparatus, characterized by a possibility of improving mixing by designing the rotor arms about the rotor shaft (2) in a fashion bent in one of the rotation directions (3). Here, the membrane surface is formed by membrane tubes (1) wound onto a rotor.

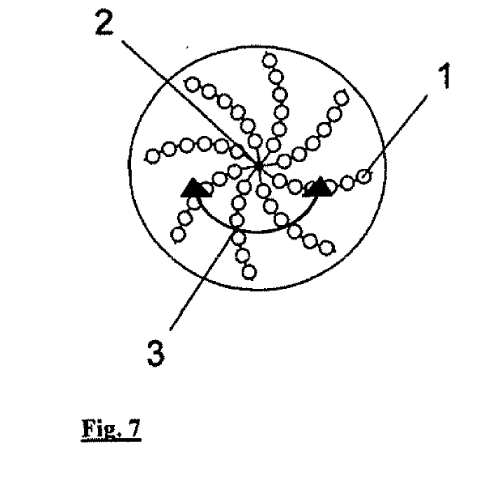

FIG. 8 is a schematic of the apparatus, characterized by a possibility of improving mixing by fitting the rotor arms on an apparatus (6) tangentially about the rotor shaft (2) in one of the rotation directions (3). Here, the membrane surface is formed by membrane tubes (1) wound onto a rotor.

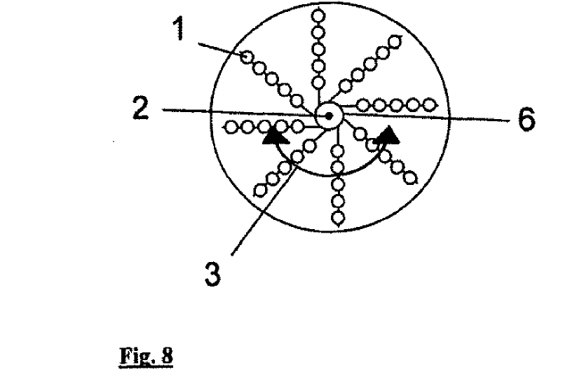

FIG. 9 is a schematic of the apparatus, characterized by a possibility of improving the mixing by fitting the rotor shaft (2) with the two rotation directions (3) eccentrically in the container. Here, the membrane surface is formed by membrane tubes (1) wound onto a rotor.

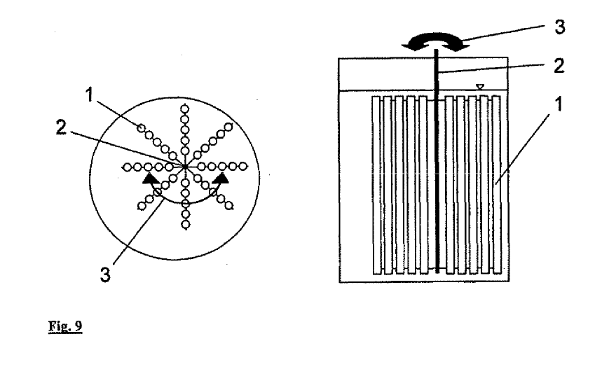

FIG. 10 is a schematic of the apparatus, characterized by a possibility of improving the mixing by virtue of the fact that the rotor shaft (2) with the two rotation directions (3) is admittedly fitted centrally in the container, but then has an eccentric (7). Here, the membrane surface is formed by membrane tubes (1) wound onto a rotor.

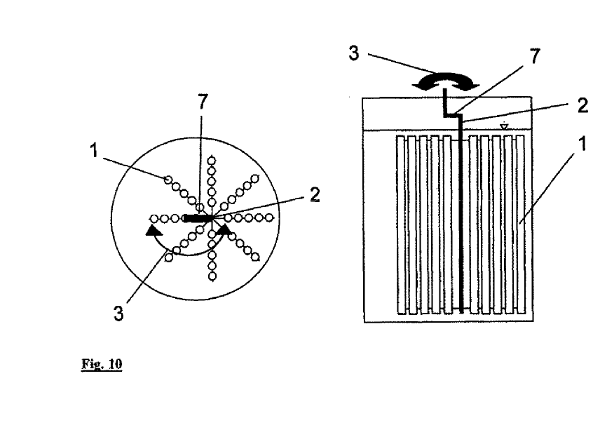

FIG. 11 is a schematic of the apparatus, characterized by a possibility of distributing the membrane surface per volume as uniformly as possible about the rotor shaft (2) with the two rotation directions (3). Here, the membrane surface is formed by membrane tubes (1) wound onto a rotor.

FIG. 12 is a schematic and shows a photo of an existing refinement of the invention without membrane tubes wound on.

FIG. 13 shows a photo of an example of the winding of the membrane tubes onto the rotor arms.

FIG. 14 illustrates the mass transfer coefficient k for a method and apparatus with a membrane tube by comparison with a membrane tube on a conventional tube stator, as a function of the volume-specific power input P/V.

FIG. 15 illustrates the volume-specific power input P/V for various amplitudes yₘₐₓ, as a function of the equivalent rotational speed f.

FIG. 16 illustrates the volume-specific and moment-specific power input P_{B}/V for various amplitudes yₘₐₓ, as a function of the equivalent rotational speed f.

FIG. 17 illustrates the movement-specific Newton number Ne_{B} for various amplitudes yₘₐₓ, as a function of the Reynolds number Re.

FIG. 18 illustrates the mass transfer coefficient k with Y-shaped rotor arms for various amplitudes yₘₐₓ as a function of the volume-specific power input P/V.

### LIST OF REFERENCE SYMBOLS

| | |
|---|---|
| 1 | Membrane tubes |
| 2 | Rotor shaft |
| 3 | Rotation direction |
| 4 | Straightening elements with the aid of which the deflection |
| | of the membrane tubes in one rotation direction is limited |
| 5 | Agitator |
| 6 | Apparatus for tangential arrangement of the rotor arms |
| 7 | Eccentric in rotor shaft |
| 8 | Tensioning apparatus for setting the membrane tube tension |
| 9, 10 | Apparatuses above and below for holding in star-shaped fashion |
| | the winding arms onto which the membrane tubes are wound |
| σ | Tube tension |

### EXAMPLE

A particular refinement of the invention and design aspects thereof are given in detail below without being limited thereto.

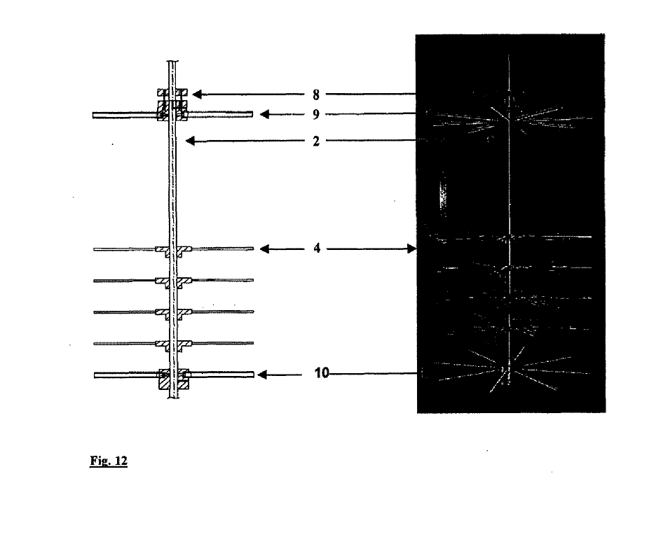

FIG. 12 shows the schematic design and a photo of the rotor without membrane tubes wound on. The elementary design parts are illustrated there.

In order to ensure a tangential flow onto the membrane tubes, the membrane tubes were fitted transverse to the flow direction. This was implemented by respectively envisioning a star-shaped apparatus above the base of the reactor and below the liquid level in the reactor. The membrane tubes are wound over the respective 8 rotor arms of the apparatuses 9 and 10 shown in FIG. 12.

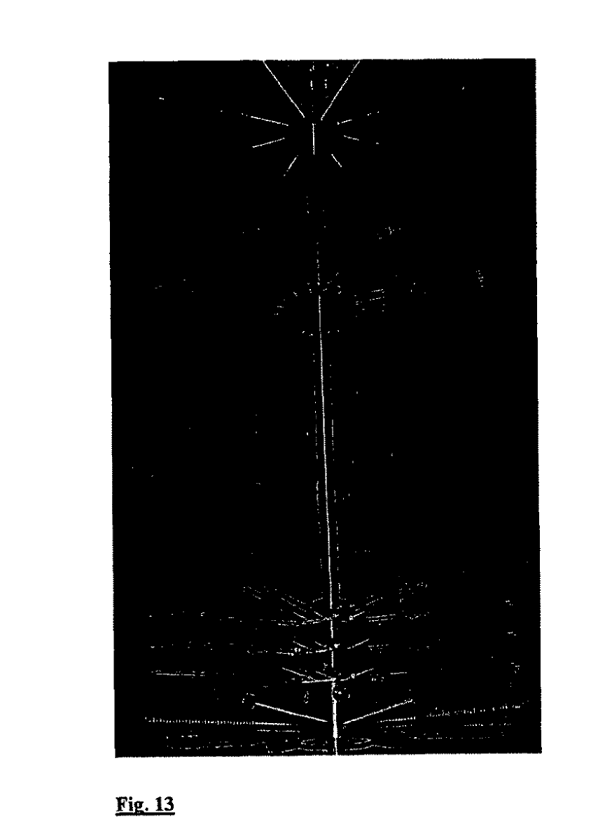

FIG. 13 shows to this end an example of a possible winding of membrane tubes onto the arms of the rotor. In this case, the membrane tubes are wound onto the winding arms without a spacing. In this example, a 25 m long tube length and a 12.5 m long tube length are wound onto each arm. Wherever a new tube length begins on the rotor arm there is necessarily a gap in the case of this winding.

If the rotor is now rotated, the membrane tubes are moved by the fluid in the reactor and therefore receive a tangential incoming flow. With regard to the incoming flow of the membrane tubes, it is to be borne in mind that, given an identical angular velocity, the incoming flow generally improves with increasing radial distance from the rotor shaft, as a function of the position of the membrane tube. The reason for this is the equally increasing circumferential speed. Thus, the aim must be to install as many membrane tubes as possible as far out as possible in conjunction with good incoming flow. One possibility of meeting this demand consists in raising the number of the arms around the shaft. However, raising the number of the arms has a negative effect both on mixing and on the incoming flow of the membrane (creation of compartments of lesser mixing between the arms). In addition, the increasing number of the arms impairs the handling of the rotor when tubes are being wound on and off, as well as during installation and removal. Again, the fastening of the arms on the shaft becomes more and more problematic with a larger number of the arms, for reasons of space. The number of eight arms appears to be a sensible compromise with regard to the issues outlined above.

The system from FIG. 12 preferably has degrees of freedom with regard to the setting of the membrane tube tension. The tube tension should be variable in order to be able to influence the mass transfer performance. The freely oscillating tubes, which are thus flowed around more effectively, should ensure a better mass transfer. The tube tension can be varied by increasing the vertical spacing between the apparatuses for holding the rotor arms. A fine setting of the tube tension is enabled after loosening the clamping screws down to the in the clamping block by rotating the screws in the clamping block.

As already touched upon, the tube tension is a variable quantity. Reducing the tube tension results in the problem of fixing the membrane tubes on the arms. Given a low tube tension, a large effect of force on the tubes could cause the membrane tubes to slip off the arms. In order to counter this problem, the surface of the arms was provided with an external thread. It was necessary here to bear in mind that the wound-on membrane tubes were not damaged by any possible burrs of the thread. Furthermore, the external thread on the winding arms offers a possibility of varying the tube winding. For example, it would be possible to use only every second or third thread depression when winding on the tubes. It is thereby possible to set a defined spacing between the individual membrane tubes.

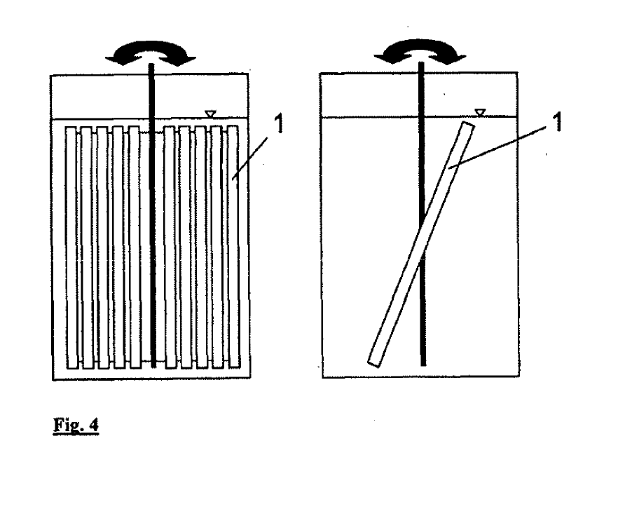

It has already been shown in the abovementioned patent EP 0172478 A1 that mixing is not without problems in the case of such a system. With regard to mixing, the movement guidance in this invention is more favorable on the basis of the oscillating rotor movement. One possibility of forcing axial mixing is to set the angle of the membrane surface. The incidence angle of the membrane tubes can be varied by arbitrarily radially rotating at least one apparatus 9 and 10 from FIG. 12 (compare also FIG. 4). From the point of view of design, it must be possible to rotate the two apparatuses independently of one another and variably relative to one another.

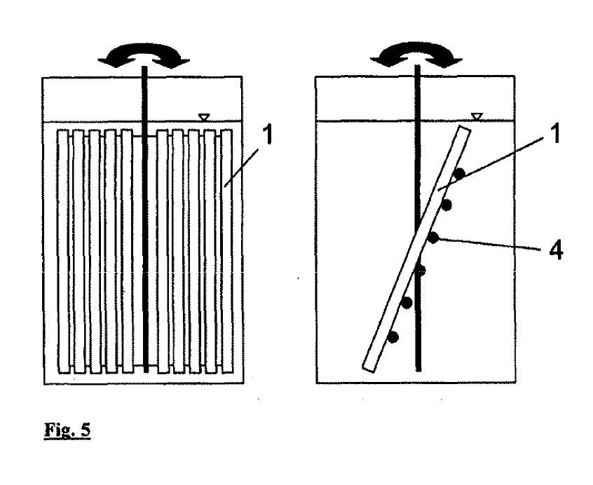

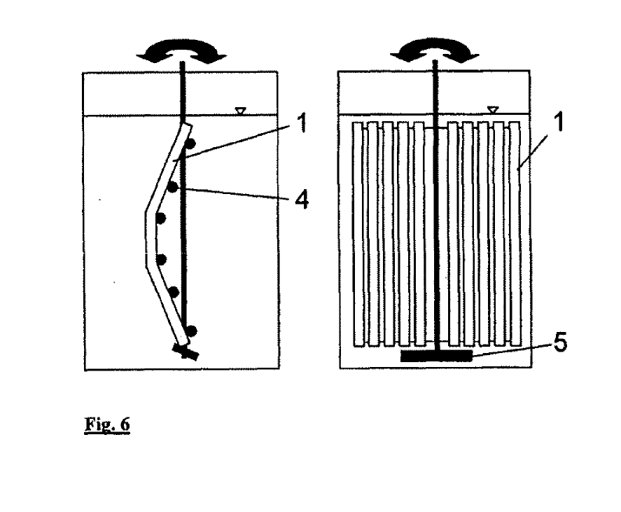

A further possibility of promoting mixing consists in supporting the membrane tubes (1) on one side against deflection (compare also FIG. 5) or of sculpting them (for example with a bulge on one side, compare also FIG. 6). The sculpting creates an asymmetry of the flow patterns of the two movement directions. In terms of design, the support and/or sculpting are permitted by the use of the apparatuses (4) from FIG. 12. These apparatuses are fashioned such that they can be mounted variably as regards both height and alignment. They can be placed and fixed as desired on the shaft by loosening or fastening two grub screws.

The design from the individual parts shown in FIG. 12 is intended to simplify the possibility of handling. Thus, the rotor arms are to be removed individually. This results in the possibility of winding the membrane tubes onto the pairs of arms before mounting on the rotor. The pairs of arms can therefore also be dismounted individually from the rotor. A winding aid was designed in order to enable separate winding of the membrane tubes onto the individual pairs of arms.

The weight of the rotor should be as low as possible so that the moment of inertia of the rotor remains as small as possible. The power to be provided for the drive can be reduced by a small moment of inertia. Consequently, from the point of view of design the invention was fashioned to be as light as possible together with sufficient stability.

The particular refinement of the invention serves the purpose of gassing a cell culture bioreactor with a liquid volume of 100 L, the inside reactor diameter being 400 mm, and the height to diameter ratio being 2:1. The central rotor shaft has a diameter of 16 mm, and the rotor has an outside diameter of 360 mm. The winding arms are designed with a diameter of 14 mm. An appropriate thread of pitch 3 mm is turned onto the winding arms in order to prevent the membrane tubes of inside diameter 2 mm and outside diameter 3 mm from slipping.

A stepping motor with a maximum rotational speed of 2500 min⁻¹, a maximum torque of 6 Nm and a gear ratio of 1:12 was used as rotor drive in the illustrated refinement of the invention. The gear was connected to the rotor via bellows couplings in order to absorb the stresses from the connection between gear and rotor.

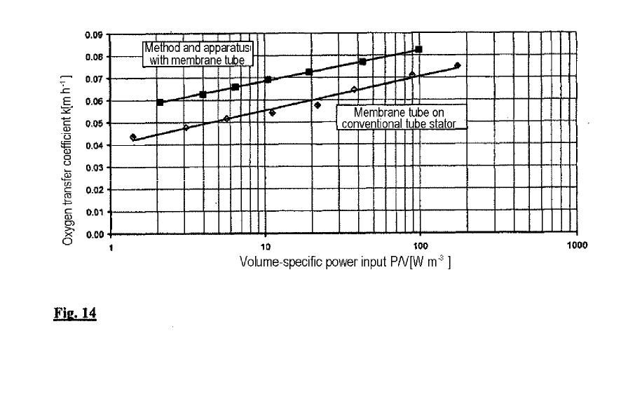

The aim below is to illustrate briefly and discuss selected measurement results of the particular refinement of the invention. To this end, the method with the apparatus outlined above was measured for the mass transfer coefficient k (for oxygen) and the volume-specific power input in the case of a volume-specific mass exchange area a of 30 m⁻¹. As reference, the same took place for the same membrane tube on a conventional tube stator (reference, volume-specific mass exchange area a of 24 m⁻¹). FIG. 14 illustrates the mass transfer coefficient k as a function of the volume-specific power input P/V. The comparison clearly shows the growth of the mass transfer coefficient k owing to the method and the apparatus. Thus, the mass transfer coefficient is approximately 30% higher given a power input of 10 W per m⁻³. It is possible to obtain growths of approximately 70% in the mass transfer coefficient given this power input if use is made of membrane tubes with an inside diameter of 1 mm, outside diameter of 1.4 mm and tube lengths of approximately 1200 mm (results not illustrated).

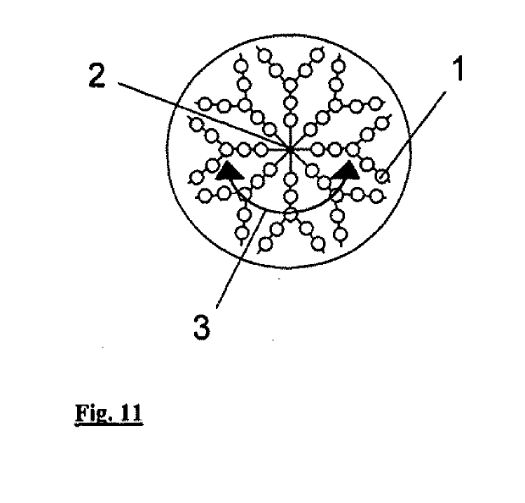

Improvements in the volume-specific mass transfer coefficient ka are possible with the aid of the method and the apparatus, because more volume-specific mass exchange area a can be used. If the volume-specific mass transfer coefficient ka of Y-shaped arms (see FIG. 11) is investigated as a function of the volume-specific power input by comparison with the measurement series “method and apparatus with membrane tube” (see FIG. 14), the volume-specific mass transfer coefficient ka is higher by 57% given an additionally used volume-specific mass exchange area a of approximately 127% (results not illustrated). In the case of the membrane tubes with an inside diameter of 1 mm, outside diameter of 1.4 mm and tube lengths of approximately 1200 mm, the mass transfer coefficient ka can be raised by 224% given an additionally used volume-specific mass exchange area a of approximately 146% (results not illustrated).

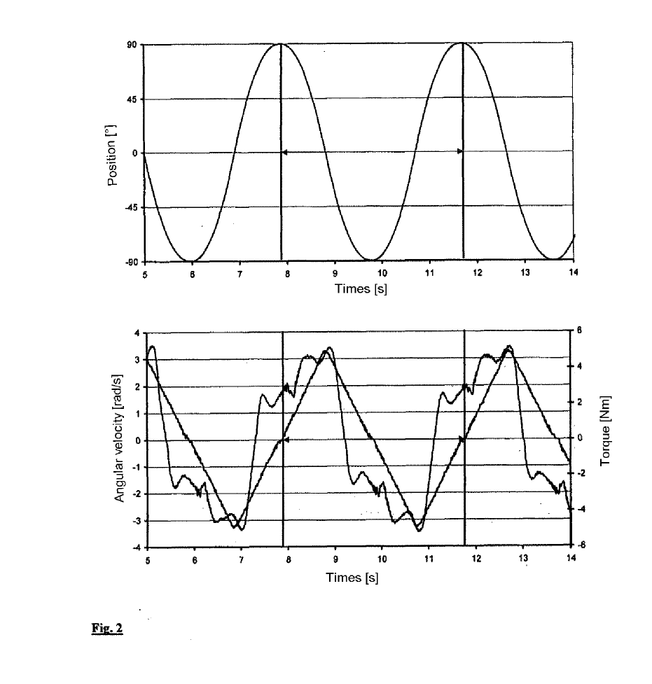

Investigations relating to rotor movement are presented in part below. The parameters varied in this case are the amplitude and acceleration of the oscillation. The measurement series presented so far were recorded for an amplitude of 180° (180° there and back, compare FIG. 2). In order to clarify whether this initially given definition also represents the variant most suitable for the system, investigations were carried out in relation to power input and mass transfer with an amplitude yₘₐₓ of 20°, 90° and 270°, in order to enable comparisons with the previous results. All measurements were carried out with Y-shaped rotor arms.

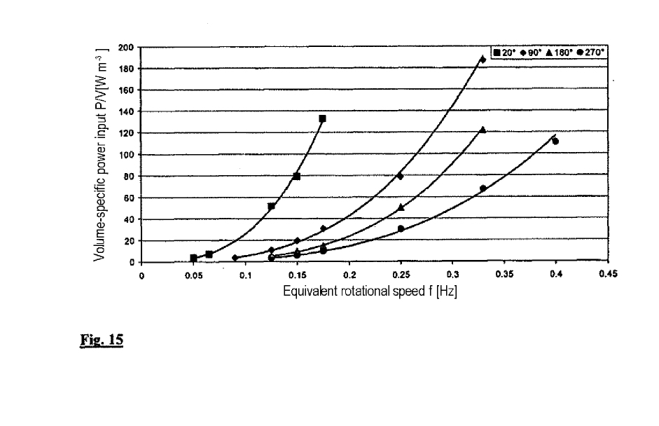

Equivalent rotational speeds in a volume-specific power range of 0-200 W per m⁻ were measured for the amplitudes deviating from 180°. The results of this measurement are illustrated in FIG. 15.

The following considerations were undertaken in order to be able to compare the results more effectively.

The equivalent rotational speed f of a movement is defined for an amplitude of 180° from the period T. This is the time required by a system in order to run through a movement cycle.

$$f = \frac{1}{25 T}$$

The equivalent rotational speed f always relates to the time that the oscillating system requires to run through 360°. In the case of the oscillation previously used with an amplitude yₘₐₓ of 180° this was easy to the extent that the system automatically covers 360° in the case of a movement there (+180°) and back (−180°). The period (or the time for a movement cycle) is automatically identical to the time for running through 360°.

If use is now made of amplitudes other than 180°, this no longer applies! It is then necessary that the period for a movement cycle T with a factor z that describes the number of requisite cycles for running through 360° be converted to a movement of 360°.

$$f = \frac{1}{z \cdot T} with z = \frac{360 °}{2 \cdot \vert {y}_{max} \vert}$$

The same is also to hold for the respectively amplitude-referred power input, which is consequently defined as movement-specific power input P_{B}.

$${P}_{B} = \frac{P}{z}$$

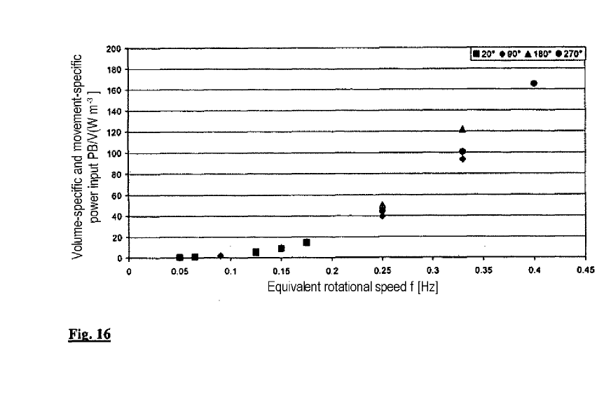

FIG. 16 illustrates the results of determining the volume-specific and movement-specific power input P_{B}/V for the various amplitudes referred to the equivalent rotational speed f. It is to be seen that all movements exhibit a similar power input characteristic. The volume-movement-specific power input rises with the corresponding equivalent rotational speed. It is possible to infer from this that the definitions formulated are justified. If the measurement results obtained are referred to a movement by 360°, it is seen that the power input by the system is dependent on the value of the amplitude.

In order to be able to carry out scaling up and scaling down of a system, it is necessary to be able to describe the system in a dimensionless fashion. Each agitation system is characterized by the dimensionless Newton number or else the power number. The Newton number is a function of the type of agitator and of the flow occurring. If the Newton number is regarded as a function of the Reynolds number, the power characteristic of the agitation system results. A constant, characteristic Newton number is set up in the turbulent flow area. The aim at this juncture is to check whether this representation and characteristic description of the oscillating system are possible in this way. The calculations were performed using the following equations:

$$Re = \frac{ρ \cdot f \cdot {D}^{2}}{η}$$

$${Ne}_{B} = \frac{{P}_{B}}{ρ \cdot {f}^{3} \cdot {D}^{5}}$$

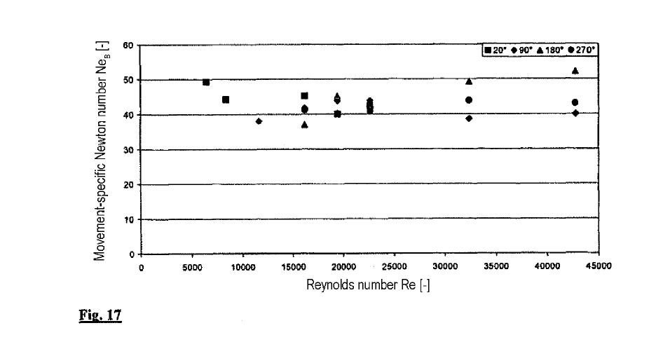

FIG. 17 illustrates the development of the movement-specific Newton number with rising Reynolds number. It is evident that the system can be described in dimensionless fashion independently of the amplitude.

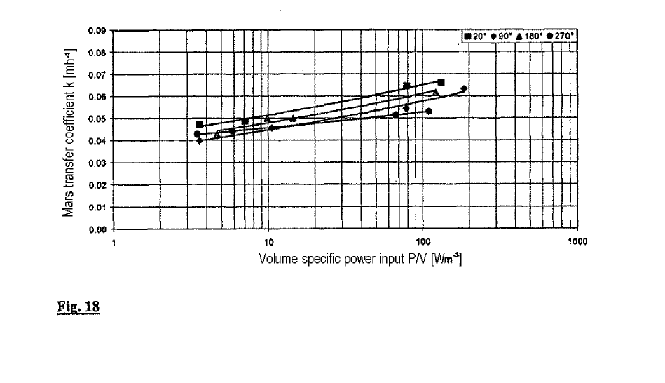

After the characterization of the method and of the apparatus functioning as agitation system, experiments were carried out to characterize the function as gassing system. Mass transfer measurements were carried out for the three selected amplitudes of 20°, 90° and 270°, and were considered comparatively with reference to the results of the 180° oscillation. The measurement results are illustrated in FIG. 18. It is evident that all measurement results are arranged in a region of +/−10% about the values for a 180° oscillation. Here, the best result is obtained by the measurement series with an amplitude of 20°. The measurement series for an amplitude of 270° exhibits a somewhat different course than the other series. A weaker dependence of the mass transfer on the power input is present here.

1. A method for the gassing of a liquid, said method comprising effecting a gas exchange over one or more membrane surfaces submerged in the liquid, wherein the one or more membrane surfaces are in arbitrary, rotating and oscillating movement in the liquid.

2. The method as claimed in claim 1, wherein the gassing rate, the power input, the mixing time and/or the shear load are controlled by changing the movement, a movement cycle not being limited to recurrent patterns.

3. The method as claimed in claim 1, wherein the gassing rate is controlled by changing the gas concentration and/or the pressure of the gas or gas mixture or a gas component flowing into a space inside the membrane surface.

4. The method as claimed in either claim 1, wherein the gassing rate is controlled by changing the gas concentration and/or pressure of the gas or gas mixture or of a gas component flowing out of a space inside the membrane surface.

5. The method as claimed in claim 1, wherein the mass transfer is increased by fitting stationary baffles, the stationary baffles disturbing a flow that forms owing to the rotating and oscillating movement of the membrane surfaces.

6. The method as claimed in claim 1, wherein a supply of the membrane surface is undertaken with the aid of flexible tubes or rotary seals for the supply and removal of gas.

7. The method as claimed in claim 1, wherein the membrane surface is used to generate microbubbles or gas bubbles in the liquid.

8. The method as claimed in claim 1, wherein rotor arms rotate about a rotor shaft in a fashion bent in one of the rotation directions.

9. An apparatus for degassing liquids in accordance with claim 1, said apparatus comprising a gas exchange via one or more submerged membrane surfaces of any sort that are fitted flexibly in the liquid to be gassed and/or degassed, said membrane surfaces being movable in a rotating and oscillating fashion.

10. The apparatus as claimed in claim 9, further comprising means for varying the tension of the membrane surface.

11. The apparatus as claimed in claim 9, further comprising means for varying the incidence angle of the membrane surface.

12. The apparatus as claimed in claim 9, further comprising means for limiting in one rotational direction a deflection of the membrane surface caused by a flow resistance.

13. The apparatus as claimed in claim 9, further comprises means for limiting for a portion of the membrane a deflection, caused by a flow resistance, of the membrane surface.

14. The apparatus as claimed in claim 9, which lacks rotational symmetry in the oscillating and rotating membrane apparatus.

15. The apparatus as claimed in claim 9, wherein the membrane surface is appropriately shaped for better mixing, and/or of fitting agitator blades/paddles or other apparatuses for flow guidance and mixing.

16. The apparatus as claimed in claim 9, which further comprises means for distributing the membrane surface per volume as uniformly as possible.

17. The apparatus as claimed in claim 9, which further comprises rotor arms fitted tangentially around the rotor shaft in one of the rotation directions.

18. The apparatus as claimed in claim 9, which further comprises a rotor shaft with two rotation directions fitted eccentrically in the container.

19. The apparatus as claimed in claim 9, which further comprises a rotor shaft with two rotation directions fitted centrally in the container, but has an eccentric.
